(19) United States
(12) Patent Application Publication
(10) Pub. No.: US 2011/0000947 A1
(43) Pub. Date: Jan. 6, 2011

(54) Perforated Bag Separation Method and Apparatus

(75) Inventor: Sam Yiu Wah Cho, Weston (CA)

Correspondence Address: CONLEY ROSE, P.C., 5601 GRANITE PARKWAY, SUITE 750, PLANO, TX, 75024, US

(73) Assignee: GAMMA MACHINERY INC., Weston (CA)

(21) Appl. No.: 12/827,183

(22) Filed: Jun. 30, 2010

Related U.S. Application Data
(60) Provisional application No. 61/222,500, filed on Jul. 2, 2009.

(51) Int. Cl. B26F 3/00; B65H 35/10; B65D 33/00

(52) U.S. Cl. 225/2; 225/100; 383/35

(57) ABSTRACT

A method and apparatus for partially separating bags in a longitudinally extended continuous flattened extruded tubular web having a series of seal lines and rupturable separation lines defining a series of separable individual bags. A rupturing member applies force perpendicular to a portion of the surface of the web while the web moves and is under tension in the longitudinal direction and thereby causes the separation lines to partially rupture, leaving a slot in the middle of each separation line and leaving the outer portions of each separation line intact, so that the position of the separation line can be readily determined by a person holding a roll of partially separated bags.

### CROSS-REFERENCE TO RELATED APPLICATIONS

This is a regular, nonprovisional application claiming the benefit of prior U.S. Provisional Application No. 61/222,500 filed Jul. 2, 2009, which is incorporated herein by reference hereto.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### FIELD OF THE INVENTION

The present invention relates generally to methods and apparatus for processing perforated bags, and more particularly to methods and apparatus for partially separating bags in a web of perforated bags.

### BACKGROUND OF THE INVENTION

Plastic bags are commonly formed from a longitudinally extended extruded tubular web by a bag making machine that creates a series of adjacent seal lines and rupturable separation lines extending transversely across the width of the web. The web, typically a tube of thermoplastic film such as a low density polyethylene film, forms a series of continuous but separable bottom sealed plastic bags. The seal lines and separation lines are generally made by a reciprocating serrated blade and sealing element that are reciprocated into and out of contact with the tubular film. Alternatively, the seal lines may be formed by a rotating drum having heated seal bars. The sealing element forms a seal across the width of the tube by melting the two faces of the flattened tube under pressure to seal them together. Each heat seal or weld line defines the bottom of one bag and the adjacent separation line defines the top and opening of the next bag in the web.

The separation lines are generally placed close to the seal lines to minimize the amount of material between them known as the skirt, which does not contribute to the volume of the bag. They may be created at the same time as the seal lines, or may be introduced later, possibly after the web has been folded one or more times. Separation lines are generally a line of perforations made so that, by applying force across the separation lines in the longitudinal direction, the bags may be separated and may then be opened. The blade generally has a uniform set of teeth that pierce the web to create regularly spaced holes or slits across its width. The perforations are generally short transverse slits corresponding to the teeth, separated by shorter sections of uncut material corresponding to the spaces between the teeth. In some cases the slits may be arcuate to produce a non-linear perforation that may make separation of the bags easier.

The bags may be wound in a roll from which users may remove bags by unrolling the web to the next separation line and then applying force across the separation line. The bags may be gusseted and/or or folded one or more times lengthwise along the longitudinal axis so that the width of the web is reduced to a fraction, such as one quarter, of the full width of the bags. For example, the bags may be fully gussetted on each side and folded lengthwise to form a star-sealed eight-ply configuration. The separation lines extend though all the layers of a folded web.

The size and width of bags varies substantially (e.g. from small sandwich bags to large garbage bags) and it is often desirable to be able to produce different sizes of bags on a single piece of machinery.

In some cases, bag making machines may include an assembly to fully separate the bags, so that individual bags, rather than a roll of connected bags, are produced.

In many cases, the location of the separation lines may be difficult for a user to find, such as under poor light conditions, which makes it difficult for a user to remove a bag from a roll. This problem has been recognized in the prior art and some approaches have been devised to address it. An approach disclosed in the prior art is to adapt the bag making machine to create perforation lines with extended slits or slots. Bag rolls have been disclosed where a center portion of the separation line has regularly spaced perforations and the remainder of the material in the line is cut by one extended perforation on either side extending to the edges. This has been accomplished by the use of a specially adapted blade having a width corresponding to the width of the web with a sequence of grooves in the central portion where the web is not cut, so that perforations are formed by the portions of the blade between the grooves, which may be referred to as teeth. This requires a different blade for each width of material that is going to be processed, which increases cost and adds time when changing the width of the web to change the blade. Such an approach may help identify the location of the separation line visually, but is less likely to help a user holding a roll to identify the line by touch since the central portion remains intact.

Bags have also been manufactured so that a central portion of the separation line is cut as one extended perforation to form a slot, and the remainder of the separation line has regularly spaced perforations extending to the edges of the bags. Such bag rolls may be used manually by holding the roll in one hand and pulling the leading bag away from the roll, thereby rotating the roll and causing the user's fingers of the hand holding the roll to engage the slot when the separation line is reached, making it easy for the user to then detach the bag. Alternatively, such rolls are often used in specialized dispensers that employ a tongue, which is a protrusion having a width less than the width of the slot and configured so that the leading bag slides over the tongue when a user pulls the bag and the tongue enters the slot when the slot passes over the tongue, thereby stopping the rotation of the roll and identifying the separation line so that the user can easily detach the bag.

While this provides a good solution to the identified problem, it requires the use of a bag making machine that is adapted to produce such irregular separation lines. The blade or mechanism used to create the perforation lines must be adapted to the particular width of the bags, increasing cost and making it more difficult to use a single machine to produce bags with varying widths.

Devices and methods have been disclosed to process a folded web comprising multiple layers so as to separate an outer layer from the other layers by rupturing the separation line for the outer layer only, which may make it easier for a user to open a bag after it is separated from the web. One approach uses a perforating blade having teeth adapted to pull the outer layer up and separate it from the other layers when the teeth are removed from the web after perforating the web. Such an approach could be adapted to separate only a central portion of the outer layer, but would then suffer from the same disadvantages as the above described approach to creating irregular perforation lines. Another approach, which has been used to separate only a central portion of an outer layer, uses a member that frictionally engages a portion of the surface of the web as it moves longitudinally when each separation line passes the member. However, this approach is complex, requiring precisely timed actions to correspond with the passing of the separation line by the member and, since it relies on applying friction to the surface of the web, would not be able to reliably separate all layers of the web to create a slot, even if there are only two layers in an unfolded configuration.

### SUMMARY OF THE INVENTION

The invention relates to a method of partially separating bags in a longitudinally extended flattened tubular web having a series of seal lines and rupturable separation lines defining a multiplicity of bags, the method comprising the steps of receiving the web and, for each separation line, applying tension longitudinally across the separation line and applying a rupturing force to a portion of the surface of the web, the rupturing force having a component perpendicular to the surface of the web sufficient to rupture a portion of the separation line.

The invention further includes an apparatus for partially separating bags in a longitudinally extended flattened tubular web having a series of seal lines and rupturable separation lines defining a multiplicity of bags, the apparatus comprising:
a. a nip roller assembly for moving the web longitudinally under tension comprising
   i. input nip rollers for receiving the web,
   ii. output nip rollers spaced apart from the input nip rollers for receiving the web from the input nip rollers, and
   iii. a drive means for driving the input and output nip rollers,
   wherein more torque is applied to the output nip rollers than the input nip rollers to maintain the web between the input and output rollers under tension, and wherein the tension alone is insufficient to cause the separation lines to rupture;
b. a rupturing member positioned to contact a portion of the surface of the web as it passes between the input and output nip rollers wherein the rupturing member applies a rupturing force to the web having a component perpendicular to the surface of the web sufficient to rupture a portion of each separation line as each separation line passes the rupturing member; and
c. a rigid frame supporting the nip roller assembly and the rupturing member.

The force perpendicular to the surface of the web may be applied continuously by a rupturing member in a fixed position in contact with the surface of the web as the web is moving longitudinally. The rupturing member may contact the surface of the web away from the edges of the web whereby the bags remain connected by two unruptured portions of the separation line extending to both edges of the web and a slot is formed by the ruptured portion of the separation line. The slot may extend across at least one quarter of the width of the web. The portion of the rupturing member in contact with the surface of the web may be less than one eighth of the width of the web and may be a roller that contacts the surface of the web and rotates with the longitudinal movement of the web so that the rupturing force applied by the rupturing member to the web is substantially perpendicular to the surface of the web.

The apparatus may also include a dancer assembly that is supported by the frame for receiving the web to match the incoming speed of the web and provide the web to the input nip rollers. The apparatus may also include a positioning means for modifying the position of the rupturing member to vary the rupturing force.

The invention further includes rolls of bags, the separation lines of which have been partially ruptured.

Other features of the invention will be evident from the disclosure of several embodiments that follows.

### BRIEF DESCRIPTION OF THE DRAWINGS

The present invention will now be described by way of example with reference to the following drawings in which:

FIG. 1 is a side view of the major components of an apparatus in accordance with the present invention with the front to the left and the rear to the right;

FIG. 2 is a rear view of the major components of an apparatus in accordance with the present invention; and

FIG. 3 is a schematic diagram showing the web path of an apparatus in accordance with the present invention.

### DETAILED DESCRIPTION OF THE INVENTION

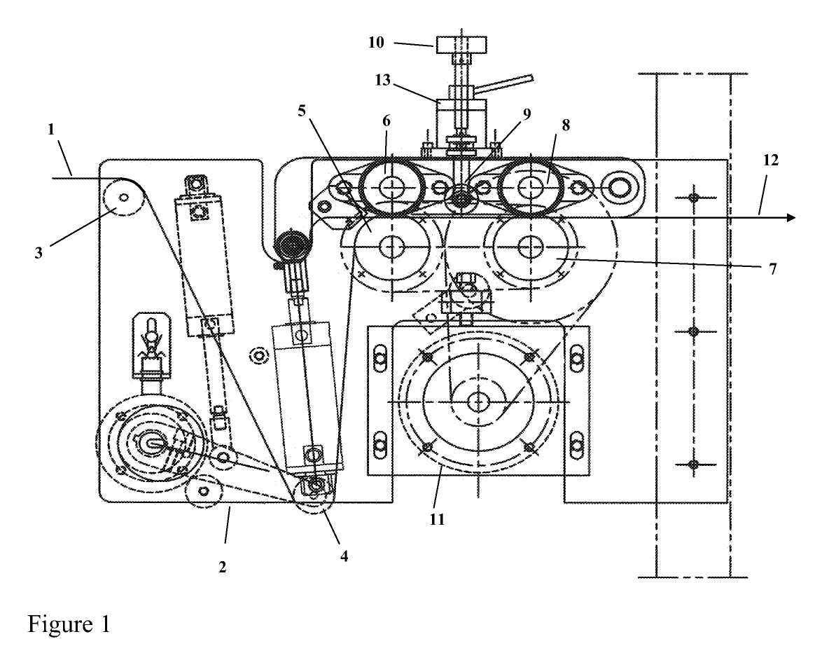

FIG. 1 shows a side view of an apparatus for partially separating bags in a longitudinally extended, continuous, flattened, extruded tubular web 1 having a series of seal lines and rupturable separation lines. Each seal line defines the bottom of one bag, and a separation line that is close to and substantially parallel to the seal line defines the top and opening of the next bag in the web 1. The seal lines and separation lines generally extend transversely across the entire width of the web 1, substantially perpendicular to the longitudinal axis of the web. The separation lines are lines where the web has been weakened so that the application of force across a separation line will cause separation of the web at that line by rupturing or tearing the web along the separation line. Typically a separation line is formed by a sequence of perforations, but other approaches are also possible. A separation line may be fully ruptured in order to remove a bag from the web, or it may be partially ruptured, at one or more places, to facilitate identification of the location of the separation line and separation of a bag by a person (or user). The present invention effects a partial rupture of each separation line in such a web.

The web 1 enters the apparatus at the left side of FIG. 1, moving to the right in the longitudinal direction, and may first engage a dancer assembly 2 to match the speed of the incoming web 1. The web 1 may first pass over an idler roller 3 and then proceed downward to a biased dancing or tensioning roller 4 and then proceed upward to engage a nip roller assembly. The dancer assembly is only required to adjust to variations in the input rate of the web 1 and is not necessary in an application, such as off-line processing, where the web 1 is received at a fixed rate.

The nip roller assembly may include a motor 11 and two pairs of nip rollers driven by the motor 11. The input nip roller pair that receives the web 1 from the dancer assembly 2 has a lower input roller 5 that is driven by the motor 11 and an adjacent upper input nip roller 6 so that the web 1 may pass between the lower input nip roller 5 and upper input nip roller 6, longitudinally to the right in FIG. 1, as they rotate. The output nip roller pair is spaced apart from the input nip roller pair and the lines of contact of the nip roller pairs with the web 1 are in a common plane. The output nip roller pair has a lower output nip roller 7 that is driven by the motor 11 and an adjacent upper output nip roller 8. The web 1, having passed through the input nip roller pair, may pass between the lower output roller 7 and upper output roller 8 as they rotate and, in the absence of any contact with the rupturing member 9, the web is maintained in the common plane between the two pairs of nip rollers.

The lower output nip roller 7 is driven with more torque than the lower input nip roller 5 so that the portion of the web 1 extending between the input and output nip roller pairs is maintained under tension. In this context, driving the lower output nip roller 7 with more torque that the lower input nip roller 5 means that the force applied by the output nip rollers to the web 1 at the point of contact with the web 1 in the longitudinal direction is greater than the force applied by the input nip rollers at their point of contact with the web 1 in the longitudinal direction. The difference between these two forces creates the tension. A rupturing member 9, which may be held in a fixed position relative to the nip roller assembly by a support bar 13, contacts the surface of the web 1 as it passes between the input and output nip roller pairs. The tension applied by the nip rollers is made to be sufficiently high that the rupturing member 9 partially separates bags at each separation line, as described below, but not high enough to cause separation lines to rupture in the absence of contact by the rupturing member 9. The vertical position of the rupturing member 9 may be modifiable by the incorporation of a positioning control 10, which may be an adjusting hand wheel whereby by turning the positioning control 10, the rupturing member 9 may be moved up or down relative to the nip roller assembly. After passing though the output nip rollers, the partially separated web 12 emerges from the apparatus and may be fed to a rewinder, packaging device or may be otherwise processed.

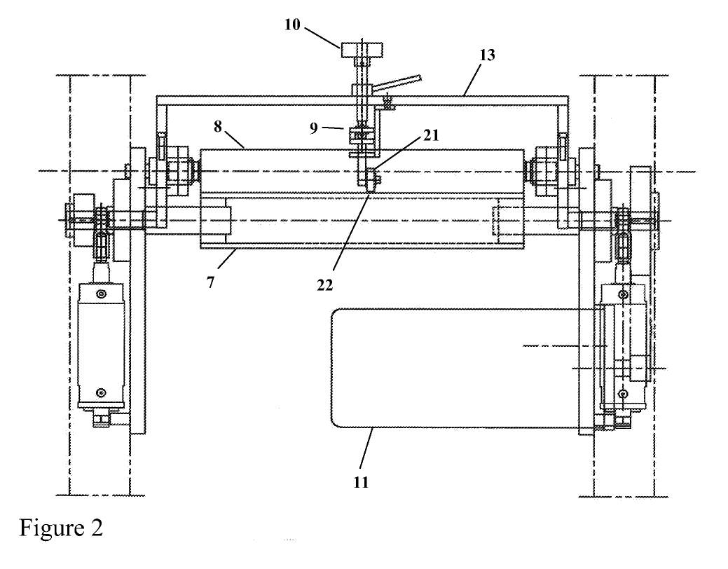

FIG. 2 shows a rear view of the major components as would be seen from the right side of FIG. 1. A support bar 13 extending parallel to the nip rollers supports the rupturing member 9 and connects to a rigid frame which connects to and supports the dancer assembly 2, in embodiments employing a dancer assembly 2, and the nip roller assembly.

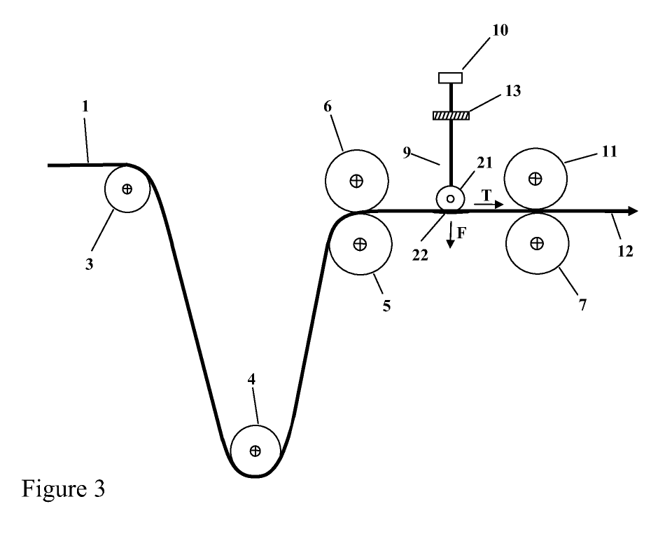

FIG. 3 provides a side view of the web path showing the rollers and rupturing member 9. FIG. 3 also shows the direction of the tensioning force T created by driving the lower output nip roller 7 with more torque than the lower input nip roller 5. The rupturing member 9 may be positioned to extend between the input and output nip roller pairs through the common plane between the two pairs of nip rollers as the tensioned web 22 passes through the nip rollers. The rupturing member 9 contacts the tensioned web 22 as it moves between the nip rollers and applies a rupturing force F, as shown in FIG. 3, having a component perpendicular to the surface of the tensioned web 22. The rupturing member 9 thereby displaces and stretches a portion of the tensioned web 22 near the point at which the rupturing member 9 contacts the surface of the tensioned web 22 (the “contact point”). By applying such force and stretching the web, the longitudinal tension, being the force applied across the surface of the tensioned web 22, is increased in the neighbourhood of the contact point. By appropriate selection of the tension T applied by the roller assembly and the vertical position of the rupturing member 9, the longitudinal tension can be adjusted to cause a portion of the separation line to rupture in the neighbourhood of the contact point when each separation line reaches the contact point. The longitudinal tension may be adjusted to determine the lateral extent of the rupture.

The rupturing member 9 is a rigid element, which may be made of metal. The portion of the rupturing member 9 that contacts the tensioned web 22 may be narrow relative to the width of the web 1. For example, it may be less than one eighth of the width of the narrowest web that it is used with, although a wider contact width may be desirable for some applications. The width of the portion of the rupturing member 9 that contacts the tensioned web 22 may be varied to modify the lateral extent of the rupture.

The lateral position of the rupturing element 9 may also be adjusted by changing the attachment point on the support bar 13, or by replacing the support bar 13 with another support bar 13 having a rupturing member attached at a different lateral position. In this way, the location of the ruptured portion of the separation line may be easily maintained near the middle of each bag, if this is desired, as webs of varying width are processed. By locating the contact point sufficiently far away from each edge, portions of each separation line extending to both edges of the web 1 may remain unruptured. Each ruptured portion of a separation line then forms a slit or slot that facilitates the identification of the position of the separation line by a person or user who wishes to remove the leading bag from a partially separated web 12. By locating the contact point at or near the middle of the width of the tensioned web 22, the slot may extend across a central portion of the perforations in each separation line spanning the center of the transverse axis of the partially separated web 12. The width of the slot may be made, for example, to be anywhere from approximately one inch, or a fraction of the width of the separated web 12 such as one quarter of the width, up to two thirds of the width of the separated web 12.

Alternatively, the rupturing member 9 may be placed closer to one of the edges of the tensioned web 22 and so cause the separation lines to rupture to the edge of the tensioned web 22 closest to the rupturing member 9, leaving the separation line intact at the other edge for a distance determined by the tensioning force T and the lateral and vertical position of the rupturing member 9. In another embodiments, two or more rupturing members may be used together, both attached to the support bar 13. For example, two rupturing members 9 may be attached to a support bar 13 so that each is positioned near one of the edges of the tensioned web 22 so that the separation lines are ruptured at both edges, leaving a central portion of the separation line intact. Such partial ruptures may be useful, for example, for use in conjunction with a dispensing box adapted to facilitate the identification of the separation lines with ruptures extended to both edges.

The rupturing member 9 may also apply some force parallel to the common plane of the nip rollers because of friction. If the frictional force is too great, it could cause tearing of the surface of the tensioned web 22 or could cause one or more layers of the tensioned web 22 closest to the rupturing member 9 to separate from the other layers. The rupturing member 9 is designed to avoid such tearing or separation by minimizing any force in the common plane. In a preferred embodiment shown in the figures, the rupturing member employs a rupturing roller 21 which contacts the surface of the tensioned web 22 and rotates at the speed at which the tensioned web 22 is moving so that the rupturing force F applied by the rupturing member 9 to the tensioned web 22 is substantially perpendicular to the surface of the tensioned web 22 and any frictional force is negligible.

The web 1 may be fed to the apparatus from a roll in an “out of line” mode or directly from a bag making machine in an “in-line” mode. For in-line operation, the apparatus can be designed to operate at any speed that bag making machines can operate at, and variations in web speed may be compensated for by the use of a dancer assembly 2.

After passing through the apparatus, the partially separated web 12, may be fed to a rewinder to wind the partially separated web 12 into rolls, either with a core or coreless, or it may be sent to an apparatus that folds the partially separated web 12 for placement in a box. Such rolls of partially separated bags may be placed in dispensers adapted to engage the separated portions to identify the separation line to a user, or may be used directly by a person so that the person's fingers engage the separated portions.

It should be noted that the rupturing member need not be perpendicular to the surface of the tensioned web 22 and may intersect the common plane at various angles while still applying a rupturing force having a sufficient perpendicular component, or applying a rupturing force substantially perpendicular to the surface of the tensioned web 22. For example, the angle between the rupturing member and the surface of the web may be sixty degrees in one embodiment. The common plane need not be horizontal and the nip roller pairs need not include an upper and lower roller. For example, the common plane may be aligned vertically and the nip roller pairs may then include left and right nip rollers. Also, either or both nip rollers may be driven by the motor.

It should also be noted that the rupturing member need not be in a fixed position, but rather may move into contact with the web periodically as each separation line passes the rupturing member so that it provides a rupturing force in the neighborhood of each separation line, thereby causing a partial rupture of each separation line.

The method employed in the described embodiments may be employed in other contexts. For example, the disclosed method may be used to create an improved bag making machine wherein a single machine produces perforated bags and partially separates them by the use of a rupturing member following the creation of the separation lines.

The foregoing are specific examples of certain aspects of the present invention. Many other embodiments, including modifications and variations thereof, are also possible and will become apparent to those skilled in the art upon a review of the invention as described herein. Accordingly, all suitable modifications, variations and equivalents may be resorted to, and such modifications, variations and equivalents are intended to fall within the scope of the invention as described herein and within the scope of the appended claims.

What is claimed is:

1. A method of partially separating bags in a longitudinally extended flattened tubular web having a series of seal lines and rupturable separation lines defining a multiplicity of bags, the method comprising the steps of receiving the web and, for each separation line, applying tension longitudinally across the separation line and applying a rupturing force to a portion of the surface of the web, the rupturing force having a component perpendicular to the surface of the web sufficient to rupture a portion of the separation line.

2. The method of claim 1 wherein the rupturing force is applied continuously by a rupturing member in a fixed position in contact with the surface of the web as the web moves longitudinally.

3. The method of claim 2 wherein the rupturing member contacts the surface of the web away from the edges of the web whereby the bags remain connected by two unruptured portions of each separation line, each unruptured portion of a separation line extending to one edge of the web, and a slot is formed by the ruptured portion of each separation line.

4. The method of claim 3 wherein the slot extends across at least one quarter of the width of the web.

5. The method of claim 2 wherein the rupturing member comprises a roller that contacts the surface of the web and rotates with the longitudinal movement of the web wherein the rupturing force applied by the rupturing member to the web is substantially perpendicular to the surface of the web.

6. The method of claim 2 wherein the width of the portion of the rupturing member in contact with the surface of the web is less than one eighth of the width of the web.

7. An apparatus for partially separating bags in a longitudinally extended flattened tubular web having a series of seal lines and rupturable separation lines defining a multiplicity of bags, the apparatus comprising:
a. a nip roller assembly for moving the web longitudinally under tension comprising
i. input nip rollers for receiving the web,
ii. output nip rollers spaced apart from the input nip rollers for receiving the web from the input nip rollers, and
iii. a drive means for driving the input and output nip rollers,
wherein more torque is applied to the output nip rollers than the input nip rollers to maintain the web between the input and output rollers under tension, and wherein the tension alone is insufficient to cause the separation lines to rupture;
b. a rupturing member positioned to contact a portion of the surface of the web as it passes between the input and output nip rollers wherein the rupturing member applies a rupturing force to the web having a component perpendicular to the surface of the web sufficient to rupture a portion of each separation line as each separation line passes the rupturing member; and
c. a rigid frame supporting the nip roller assembly and the rupturing member.

8. The apparatus of claim 7 further comprising a dancer assembly that is supported by the frame for receiving the web to match the incoming speed of the web and provide the web to the input nip rollers.

9. The apparatus of claim 7 further comprising a positioning means for modifying the position of the rupturing member to vary the rupturing force.

10. The apparatus of claim 7 wherein the rupturing member contacts the surface of the web away from the edges of the web whereby the bags remain connected by two unruptured portions of each separation line, each unruptured portion of a separation line extending to one edge of the web, and a slot is formed by the ruptured portion of each separation line.

11. The apparatus of claim 10 wherein the slot extends across at least one quarter of the width of the web.

12. The apparatus of claim 7 wherein the rupturing member comprises a roller that contacts the surface of the web and rotates with the movement of the web wherein the rupturing force applied by the rupturing member to the web is substantially perpendicular to the surface of the web.

13. The apparatus of claim 7 wherein the width of the portion of the rupturing member in contact with the surface of the web is less than one eighth of the width of the web.

14. A roll of plastic bags comprising a flattened tubular web having a longitudinal axis and having a series of seal lines and separation lines defining a multiplicity of bags, each separation line comprising a line of perforations extending transversely, perpendicular to the longitudinal axis, substantially across the entire width of the web, a central portion of the perforations of each separation line having been ruptured to form a slot through the web.

15. The roll of claim 14 wherein the slot extends across at least one quarter of the width of the web.

16. A roll of plastic bags comprising a flattened tubular web having a longitudinal axis and having a series of seal lines and separation lines defining a multiplicity of bags, each separation line comprising a line of perforations extending transversely, perpendicular to the longitudinal axis, substantially across the entire width of the web, the perforations of portions of each separation line extending to each edge of the web having been ruptured with a central portion of each separation line remaining intact.
